(19) United States
(12) Patent Application Publication
(10) Pub. No.: US 2016/0314589 A1
(43) Pub. Date: Oct. 27, 2016

(54) MEDICAL IMAGE DISPLAYING DEVICE AND A NON-TRANSITORY COMPUTER-READABLE RECORDING MEDIUM

(71) Applicant: KONICA MINOLTA, INC., Tokyo (JP)

(72) Inventors: Kenji NAGAO, Tokorozawa-shi (JP); Takafumi NANJO, Tokyo (JP)

(73) Assignee: KONICA MINOLTA, INC., Tokyo (JP)

(21) Appl. No.: 15/130,669

(22) Filed: Apr. 15, 2016

(30) Foreign Application Priority Data
Apr. 27, 2015 (JP) 2015-089971

(51) Int. Cl. G06T 7/00; G06T 1/00; G06T 11/60

(52) U.S. Cl. CPC G06T 7/0016; G06T 11/60; G06T 1/0007; G06T 2207/10081; G06T 2207/10088; G06T 2207/30004

(57) ABSTRACT

A medical image displaying device includes an acquirer, a sorter, an extraction unit, a coordination unit and a display controller. The acquirer acquires multiple groups of tomographic images of multiple examinations to be compared with each other from a storage that stores the multiple groups of tomographic images captured in multiple tomographic examinations of a subject . The sorter sorts the acquired groups of tomographic images captured in the examinations in the forward or reverse order along an imaging direction. The extraction unit extracts a subgroup of tomographic images containing a lesion region from each acquired group of the tomographic images captured in the examinations. The coordination unit coordinates the subgroups of the tomographic images captured in the multiple examinations. The display controller to sequentially display the tomographic images one by one captured in the examinations in the same display area on a display.

### CROSS REFERENCE TO RELATED APPLICATION

The present U.S. application claims a priority under the Paris Convention of Japanese Patent Application No 2015-089971 filed on Apr. 27, 2015, the entirety of which is incorporated herein by reference.

### BACKGROUND OF THE INVENTION

1. Field of the Invention

The present invention relates to a medical image displaying device and a non-transitory computer-readable recording medium.

2. Description of Related Art

In medical care facilities, such as hospitals, a follow-up is performed which involves comparison of current medical images containing lesion regions with past images to track geometric and dimensional changes in the lesions. In the follow-up, if the current image and the past image are disposed separately in different display areas (for example, on multiple monitors or in divided areas of one monitor), region of interests (ROIs) or comparative lesion regions are away from each other depending on the sizes of the display areas, which may lead to large gaze shift and difficulties in determining a minor change in the lesion.

Japanese Patent Laid-Open Publication No. 2009-72412, for example, describes a method of displaying medical images on one display area in the order of the current one, the first past one (captured at the latest examination), the second past one, the third past one, and so forth. If each examination has slice images, the slice images are coordinated such that corresponding slice images in each examination are displayed at the same position in one image display area, and are changeably displayed from examination to another.

The technology described in Japanese Patent Laid-Open Publication No. 2009-72412 can alternately display the current image and the past images on one display area to reduce gaze shift between the images and help to see a minor change in a lesion over time. However, if one examination involves multiple slice images (tomographic images), as in tomography, the technology compares mere changes between the slice images of plural examinations and cannot solve the problem of the gaze shift for tracking three-dimensional geometric and dimensional changes in a lesion (changes in the two directions along a slice plane and imaging direction, that is, three-dimensional changes in geometry and size) between plural examinations, and thus still requires gaze shifts over multiple display areas.

An object of the present invention is to make it possible to readily determine a three dimensional change and a difference in a lesion between plural examinations without gaze shift.

### SUMMARY OF THE INVENTION

To solve the above described object, according to one aspect of the present invention, there is provided a medical image displaying device including an acquirer to acquire multiple groups of tomographic images of multiple examinations to be compared with each other from a storage that stores the multiple groups of tomographic images captured in multiple tomographic examinations of a subject; a sorter to sort the acquired groups of tomographic images captured in the multiple examinations in the forward or reverse order along an imaging direction; an extraction unit to extract a subgroup of tomographic images containing a lesion region from each acquired group of the tomographic images captured in the multiple examinations; a coordination unit to coordinate the subgroups of the tomographic images captured in the multiple examinations, the subgroups of the tomographic images being sorted by the sorter and extracted by the extraction unit; and a display controller to sequentially display the tomographic images one by one captured in the multiple examinations in the same display area on a display, the tomographic images being coordinated by the coordination unit.

According to another aspect of the present invention, there is provided a non-transitory recording medium having a program thereon for making a computer function as a storage that stores multiple groups of tomographic images captured in multiple tomographic examinations of a subject; an acquirer to acquire the multiple groups of tomographic images of multiple examinations to be compared with each other from the storage; a sorter to sort the acquired groups of tomographic images captured in the multiple examinations in the forward or reverse order along an imaging direction; an extraction unit to extract a subgroup of tomographic images containing a lesion region from each acquired group of the tomographic images captured in the multiple examinations; a coordination unit to coordinate the subgroups of the tomographic images captured in the multiple examinations, the subgroups of the tomographic images being sorted by the sorter and extracted by the extraction unit; and a display controller to sequentially display the tomographic images one by one captured in the multiple examinations in the same display area on a display, the tomographic images being coordinated by the coordination unit.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic illustration of an entire medical image displaying system according to one embodiment;

FIG. 2 is a block diagram illustrating a functional configuration of a client terminal shown in FIG. 1;

FIG. 3 is a flow chart illustrating display control performed by a controller shown in FIG. 2;

FIG. 4A illustrates an example where a position of lesion on a tomographic image is not aligned between plural examinations;

FIG. 4B illustrates an exemplary positional adjustment of tomographic images between multiple examinations;

FIG. 5A illustrates exemplary information as to which examinations (in chronological order) and which slice positions the tomographic images displayed on a display indicate;

FIG. 5B illustrates exemplary information as to which examinations (in chronological order) and which slice positions the tomographic images displayed on a display indicate;

FIG. 5C illustrates exemplary information as to which examinations (in chronological order) and which slice positions the tomographic images displayed on a display indicate; and

FIG. 6 is a schematic view of a group of tomographic images captured in multiple examinations through the display control shown in FIG. 3.

### DESCRIPTION OF THE PREFERRED EMBODIMENTS

Preferred embodiments according to the present invention will now be described with reference to the attached drawings. It is noted that these examples shown in the drawings should not be construed to limit the present invention.

[Configuration of Medical Image Displaying System 100]

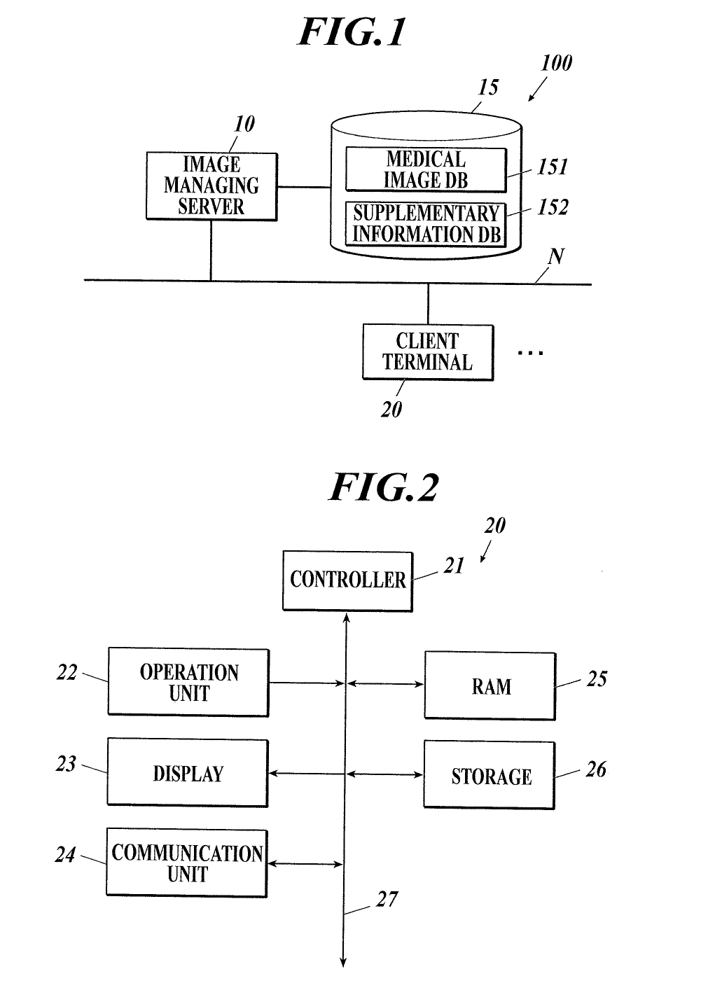

FIG. 1 illustrates an exemplary configuration of the medical image displaying system 100.

The medical image displaying system 100 is installed in a hospital. As shown in FIG. 1, the medical image displaying system 100 includes an image managing server 10 as a storage, and a client terminal 20 as a medical image display device. These devices are connected each other via a communication network N including communication lines, such as a local area network (LAN) and a wide area network (WAN). All devices included in the medical image displaying system 100 comply with the digital image and communications in medicine (DICOM) standard and communicate with each other according to the standard. The system 100 may include two or more image managing severs 10 and client terminals 20.

The image managing server 10 is a computer system that stores and manages data and supplementary information on medical images generated by various types of modality, such as a computed tomographic (CT) device, a magnetic resonance imaging (MRI) device, and a computed radiographic (CR) device. The medical images include tomographic images generated by CT and MRI devices, and plain radiographs generated by CR, devices. Specifically, the image managing server 10 has a storage 15 including a hard disk drive or the like. The storage 15 stores a medical image DE (Data Base) 151 to store the data of the medical images, and a supplementary information DB 152 to store retrievable supplementary information on the medical images in the medical image DB 151.

The medical images in the medical image DB 151 are in the DICOM file format that complies with the DICOM standard. The DICOM file has an image area and a header. The image area and the header store the actual data and the supplementary information on the medical image, respectively.

The supplementary information includes, for example, patient information, examination information, series information, and detailed image information.

The patient information includes patient identifying information (for example, a patient ID) for identifying a patient, and various types of information, such as a name, a sex, and a birth date of the patient.

The examination information includes examination identifying information (for example, examination ID) for identifying the examination, examination date, and various types of information on the examination, such as the name of a doctor in charge.

The series information includes various types of information on series such as series numbers for identifying the series having medical images in one examination, types of the modality used for generation of the medical images included in the series, examination regions, slice intervals in the case of tomographic medical images, and the total number of slices.

The term “series” herein refers to a group of consecutive medical images related to each other. For example, a CT device and an MRI device continuously capture images of a certain region of a human body (for example, from the chest to the abdomen) along the direction of the body axis (for example, from a head to a foot) at a predetermined slice interval (for example, 1 mm) multiple times, and thereby generate multiple (100 to several thousands of) tomographic images. This group of generated tomographic images is regarded as one series. All tomographic images included in the same series have the same series information. The total number of slices equals to the total number of tomographic images belonging to the same series.

In this embodiment, if one examination includes multiple series, these series have different imaging regions. In other words, it is assumed that doctors do not compare and read plural series in the same examination.

The detailed image information includes various types of information on the image such as an image number, a slice position (position measured in the direction of the body axis from a reference point (0 mm) where the first tomographic image is captured in one series), an image generation time, a file path name showing a site storing the medical image, an examination comment, a range of measurement of a lesion, and results of measurement.

The image numbers 1 to n (n is the total number of slices) indicate the order of the medical images captured in the same series.

In response to a search requirement from the client terminal 20 through the communication network N, the image managing server 10 retrieves medical images satisfying a condition sent from the client terminal 20, with the supplementary information DE 152 as a search tag, and then sends the data list of the medical images satisfying the condition to the client terminal 20. In addition, the image managing server 10 reads the data of the medical image requested from the client terminal 20 from the medical image DB 151 and then sends the data to the client terminal 20.

[Configuration of Client Terminal 20]

The client terminal 20 is a computer system for acquiring and displaying a medical image stored in the image managing server 10 for interpretation by a medical doctor.

FIG. 2 illustrates a functional configuration of the client terminal 20.

As shown in FIG. 2, the client terminal 20 includes a controller 21, an operation unit 22, a display 23, a communication unit 24, a RAM 25, a storage 26, and a bus 27 connecting these units.

The controller 21 includes a central processing unit (CPU) and the like. The controller 21 loads various programs in a work area in the RAM 25. The programs include an operation system program and a display controlling program stored in the storage 26. The controller 21 controls all units under instructions contained in the programs. The controller 21 functions as an acquirer (an acquisition unit), a sorter, an extraction unit, a coordination unit, and a display controller.

The operation unit 22 includes a keyboard and a pointing device, such as a mouse. The keyboard has cursor keys, numeric keys, and several functional keys. Instruction signals from the keyboard and the mouse are output to the controller 21.

The display 23 includes a display monitor, such as a liquid crystal display (LCD) and a cathode ray tube (CRT), which displays various menus and medical images according to display signals from the controller 21.

The communication unit 24 includes a LAN adapter, a router, and a terminal adapter (TA) and transfers data from or to all devices connected to the communication network N.

The RAM 25 defines a work area that temporarily stores various programs read from the storage 26, input and output data, and parameters before and during various processes performed by the controller 21.

The storage 26 includes a hard disk drive (HDD), a non-volatile semiconductor memory or the like.

The storage 26 stores various programs such as the operation system program to be executed in the controller 21 and the display controlling program, and data required for executing these programs. The programs are stored in the form of computer-readable codes in the storage 26. The controller 21 sequentially performs operations according to the program codes.

[Operation of Client Terminal 20]

An operation according to the embodiment will now be described.

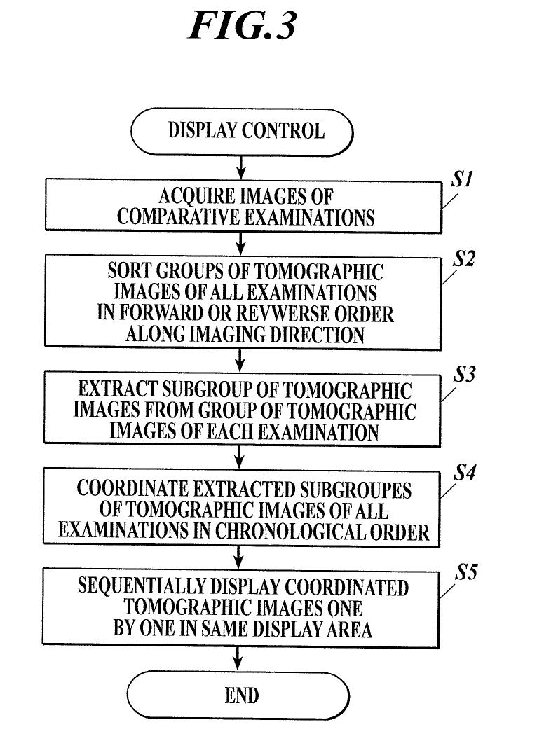

FIG. 3 illustrates a flow of the display control performed in the client terminal 20 after the client terminal 20 receives an instruction through the operation unit 22 to compare and read tomographic images. The display control is performed by software processing realized by the controller 21 and the display controlling program stored on the storage 26.

The controller 21 acquires groups of tomographic images captured in plural examinations from the image managing server 10, for comparison (Step S1).

Specifically, the controller 21 displays a search menu on the display 23, through which an operator, such as a medical doctor, enters search conditions. The operator operates the operation unit 22 to enter, for example, an examination date, an examination ID, a patient ID, and a combination thereof. Upon input of the search conditions for medical images through the operation unit 22, the controller 21 sends the input search condition and instruction through the communication unit 24 to the image managing server 10, and acquires a data list of examinations satisfying the search conditions from the image managing server 10. After the data list is acquired, the controller 21 displays an image selecting menu (not shown) based on the acquired data list on the display 23. The data list for each examination (or for each series for an examination including multiple series) is displayed on the image selecting menu. The data list includes, for example, an examination ID, a patient ID, a patient name, a type of modality, an examination region and direction, and a series number, from which the operator can select examinations to be compared. Upon the selection of the plural examinations to be compared from the data list on the display 23 and an entry of a display requirement through the operation unit 22 by the operator, the controller 21 acquires groups of tomographic images of the requested examinations from the image managing server 10 to store them in the RAM 25.

The controller 21 then sorts the groups of the tomographic images of each examination in the forward or reverse order along an imaging direction (in the same direction for all examinations) (Step S2). The term “imaging direction” is a direction along which slice positions for imaging are sequentially shifted. For example, the imaging direction is a direction from a head to a foot if imaging is carried out from the head to the foot of a patient by shifting the slice positions in this direction and a direction from a foot to a head if imaging is carried out from the foot to the head.

The controller 21 then extracts a subgroup of tomographic images containing a lesion from a group of tomographic images of each examination (Step S3).

Any technique is applicable to extract the tomographic images in Step S3. For example, a group of tomographic images may be displayed one by one for each examination in sequence or displayed side by side at the same time on the display 23. A user may then operate the operation unit 22 (for example, clicks the appropriate tomographic images) to specify a leading image and a trailing image containing a lesion from the subgroup of tomographic images, so that the specified leading and trailing images and images therebetween may be extracted as tomographic images containing a lesion of the examination.

Alternatively, a lesion region may be automatically extracted from each tomographic image of each examination w a region extracting algorithm, and the tomographic images containing the lesion therein are then extracted. Any known region extracting algorithm may be used, for example, the split and merge algorithm and the clustering algorithm (k-means algorithm). To improve the accuracy of lesion extraction and to reduce the extraction time, an ROI may be specified before the region is extracted. For example, a user may define the periphery of the lesion in tomographic images containing the lesion to define the ROI through an operation of the operation unit 22, and then the region extracting algorithm may automatically extract the lesion region from the defined ROI. This operation may also be applied to the previous and next tomographic images to specify a leading image and a trailing image containing the lesion, and then extract the leading and trailing images and images therebetween as tomographic images containing the lesion. The ROI may be defined manually by a user. If the supplementary information includes a measuring point of the lesion, a region including the measuring point and a marginal periphery may be defined as an ROI.

The controller 21 then coordinates the extracted subgroups of the tomographic images captured in the plural examinations in chronological order (Step S4). This coordination can be performed by any means. For example, the subgroups of the tomographic images may be coordinated in the order of the past one to the current one or vice versa in reference to examination dates contained in the supplementary information on each examination.

The positions of the lesions may vary between examinations because of variations in positioning for imaging in each examination, which variations may result in a displacement of a lesion on the images between the plural examinations. The subgroups of the tomographic images may be aligned to each other before being coordinated such that a reference point of each tomographic image after coordination is displayed at the same position on the display.

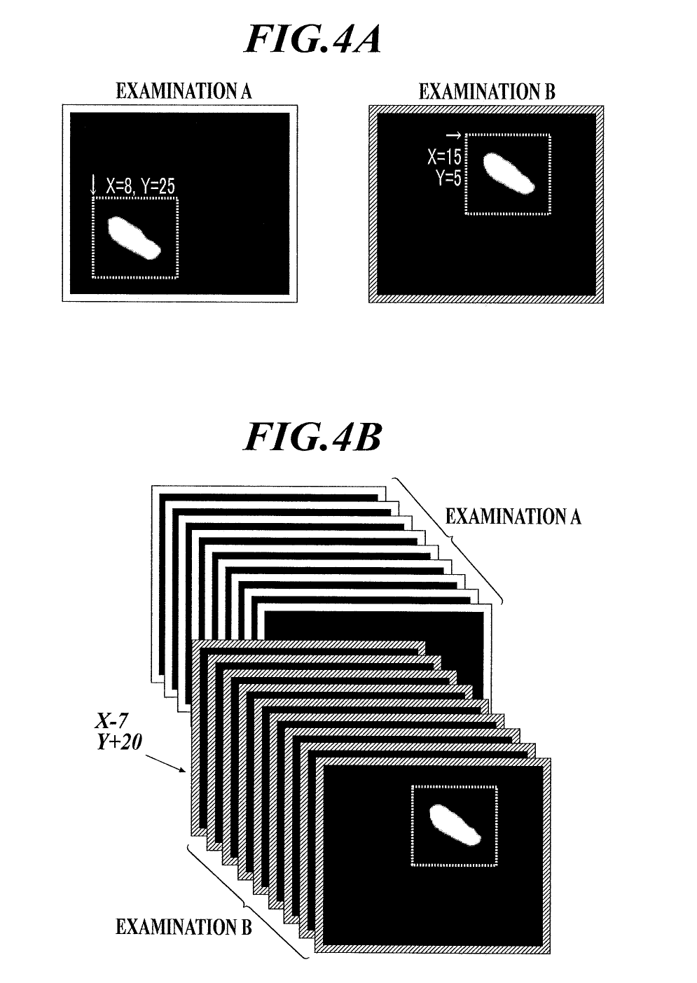

For example, in the case where reference points of examinations A and B have coordinates (8, 25) and (15, 5), respectively, as shown in FIG. 4A (where coordinates (0, 0) is the upper left end of the image), the reference point of the examination B may be displaced by −7 in the X direction and +20 in the Y direction before coordination, as shown in FIG. 4B. These positions may be adjusted by a user in such a manner that the user operates the operation unit 22 to click the reference point of all examinations, then the controller 21 calculates the displacement of the reference point between the examinations, selects one examination as a base examination, and moves all images of the other examinations such that the images are aligned with the base examination. In another embodiment, a user may operates the operation unit 22 to move (for example, drag) all images, such that reference points of examinations are aligned with that of the base examination. Alternatively, the region extracting algorithm described above may be used to extract a lesion region, and then, for example, a weighted center of the lesion region may be used as a reference point to align reference points between examinations.

After the coordination of the subgroups of tomographic images, the controller 21 displays the coordinated tomographic images serially one by one on the screen (in the same display area) of the display 23 in response to an operation of the operation unit 22 (Step S5). The images can be changed by, for example, a stroke of an arrow key of the operation unit 22 or an operation of a mouse wheel. Alternatively, the images may be automatically changed after a predetermined period of time.

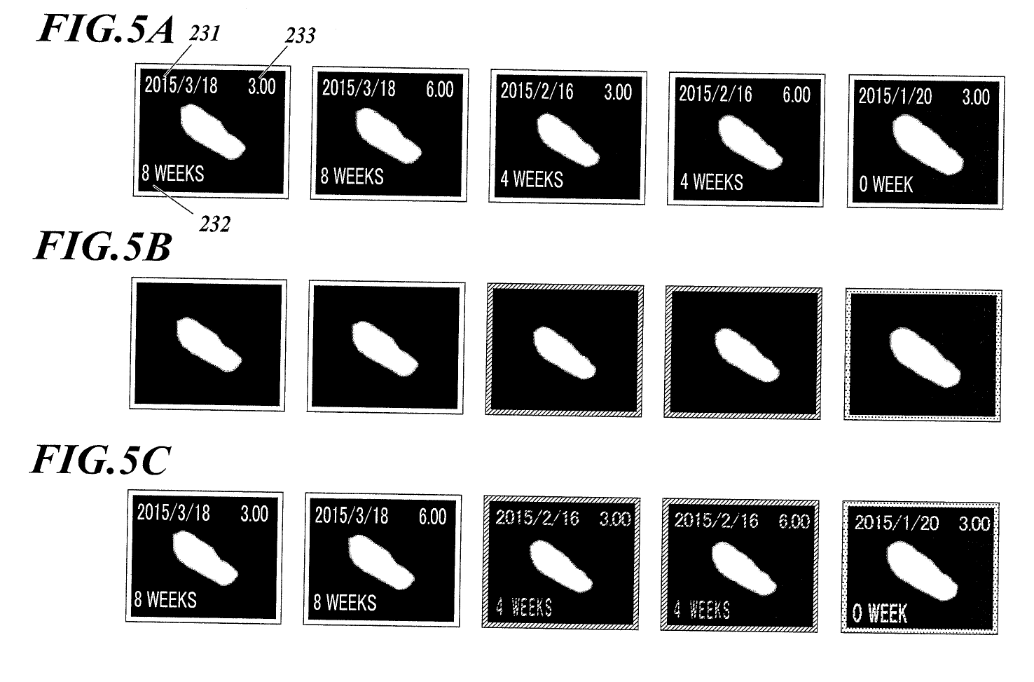

When the controller 21 displays tomographic images one by one on the display, the controller 21 also displays information on each slice position of each examination (in chronological order) of the tomographic image at a position on the display 23 so as not to interrupt reading of the tomographic image. As shown in FIG. 5A, for example, a time stamp 231, a comment 232 (a comment on the days after the onset of a lesion, in this example), and a slice position 233 and the like are displayed as overlaid information. Alternatively, as shown in. FIG. 5B, the color of the image frame (frame) may be changed every examination. As shown in FIG. 5C, the overlaid information shown in FIG. 5A and the color of the image frame of each examination shown in FIG. 5B may be displayed together.

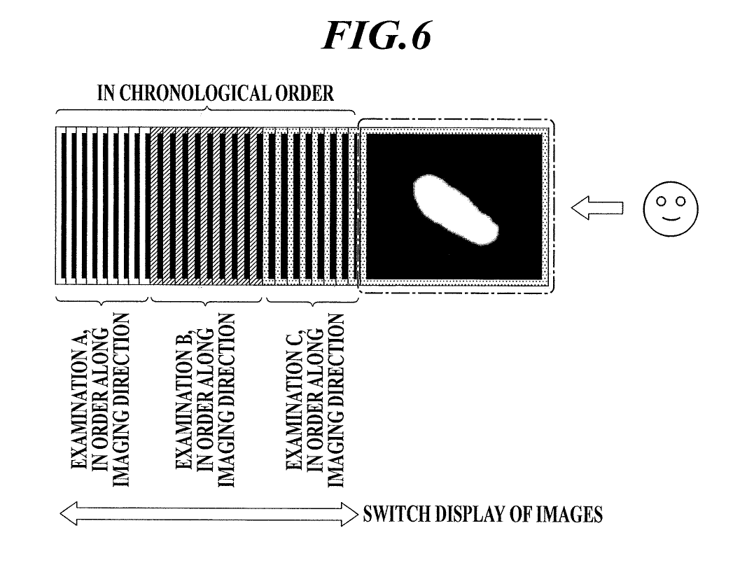

FIG. 6 illustrates a schematic display for comparative reading of the subgroups of the tomographic images in the plural examinations according to the display processing described above. As shown in FIG. 6, the tomographic images along the same imaging direction of the plural examinations are displayed one by one in chronological order on the same display screen (in the same frame). This can reduce the reader's gaze shifts and lead to easy determination of a three-dimensional change in a lesion over time during the comparison reading of the subgroups of tomographic images in the same site of the same patient in different examinations.

The display control described above is not always applied to comparison of the lesions at the same cite of the same patient captured in different times, but also applicable to comparison of lesions of different patients with respect to the same cite. The display control applied to the comparison of the lesions of different patients with respect to the same cite facilitates determination of any three-dimensional difference between patients. In this case, the plural examinations may be coordinated in any order other than chronological order.

As described above, the controller 21 of the client terminal 20 acquires groups of tomographic images of multiple comparative examinations from the image managing server 10, sorts the acquired groups of tomographic images of the examinations in the forward or reverse order along an imaging direction, and extracts a subgroup of tomographic images containing a lesion from each examination. The subgroups of tomographic images captured in the examinations, which are sorted in the forward or reverse order along the imaging direction and contain the lesion regions, are then coordinated each other, and the coordinated tomographic images of examinations are sequentially displayed one by one in the same display area of the display 23.

An image reader, therefore, can readily determine a three dimensional change and a difference in the lesion between the examinations without gaze shifts.

In an example where examinations involve capturing images of the same site of the same patient in different times, preferably, the controller 21 coordinates the subgroups of tomographic images captured in the examinations in time series. This process allows an image reader to readily determine a three-dimensional change in a lesion in follow-up without gaze shifts.

The tomographic images of the plural examinations are displayed together with information for identifying the examinations and/or slice positions of the tomographic images. This process allows the image reader to readily identify the slice positions and the examinations of the tomographic images being displayed.

At the coordination of the subgroups of the tomographic images of plural examinations, the relative positions of the tomographic images between the examinations are adjusted such that reference points of the tomographic images after coordination are displayed at the same position. This process prevents displacements of lesion positions between the examinations caused by positional changes between tomographic images, and can display the tomographic images which a reader can readily compare.

The descriptions in the embodiments and modifications above are preferred examples of medical image displaying system according to the present invention. The present invention can also include any other embodiment.

In the example disclosed above, the computer readable medium for the program according to the present invention a hard disk drive, a non-volatile semiconductor memory or the like. The computer readable medium may be any drive or medium. Examples of the other computer readable medium include portable storage media, such as a CD-ROM. In addition, carrier waves (transmission waves) can also be used as a medium that provides the program according to the present invention via a communication line.

Devices included in the medical image displaying system and operations thereof may be accordingly modified without departing from the spirit of the invention.

What is claimed is:

1. A medical image displaying device comprising:
an acquirer to acquire multiple groups of tomographic images of multiple examinations to be compared with each other from a storage that stores the multiple groups of tomographic images captured in multiple tomographic examinations of a subject;
a sorter to sort the acquired groups of tomographic images captured in the multiple examinations in the forward or reverse order along an imaging direction;
an extraction unit to extract a subgroup of tomographic images containing a lesion region from each acquired group of the tomographic images captured in the multiple examinations;
a coordination unit to coordinate the subgroups of the tomographic images captured in the multiple examinations, the subgroups of the tomographic images being sorted by the sorter and extracted by the extraction unit; and
a display controller to sequentially display the tomographic images one by one captured in the multiple examinations in the same display area on a display, the tomographic images being coordinated by the coordination unit.

2. The medical image displaying device according to claim 1, wherein the multiple examinations include capturing the tomographic images of the same position of the same patient at different times, and
the coordination unit coordinates the subgroups of the tomographic images captured in the multiple examinations in chronological order.

3. The medical image displaying device according to claim 1, wherein the display controller further displays identifying information as to which examination and/or which slice position the displayed tomographic image was captured, when the displayed tomographic images captured in one of the multiple examinations is changed.

4. The medical image displaying device according to claim 2, wherein the display controller further displays identifying information as to which examination and/or which slice position the displayed tomographic image was captured, when the displayed tomographic images captured in one of the multiple examinations is changed.

5. The medical image displaying device according to claims 1, further comprising an adjustment unit to adjust relative positions between the tomographic images captured in the multiple examinations such that reference points of the tomographic images are displayed at the same position at the coordination of the subgroups of tomographic images captured in the multiple examinations.

6. The medical image displaying device according to claim 2, further comprising an adjustment unit to adjust relative positions between the tomographic images captured in the multiple examinations such that reference points of the tomographic images are displayed at the same position at the coordination of the subgroups of tomographic images captured in the multiple examinations.

7. The medical image displaying device according to claim 3, further comprising an adjustment unit to adjust relative positions between the tomographic images captured in the multiple examinations such that reference points of the tomographic images are displayed at the same position at the coordination of the subgroups of tomographic images captured in the multiple examinations.

8. A non-transitory recording medium having a program thereon for making a computer function as:
an acquirer to acquire multiple groups of tomographic images of multiple examinations to be compared with each other from a storage that stores the multiple groups of tomographic images captured in multiple tomographic examinations of a subject;
a sorter to sort the acquired groups of tomographic images captured in the multiple examinations in the forward or reverse order along an imaging direction;
an extraction unit to extract a subgroup of tomographic images containing a lesion region from each acquired group of the tomographic images captured in the multiple examinations;
a coordination unit to coordinate the subgroups of the tomographic images captured in the multiple examinations, the subgroups of the tomographic images being sorted by the sorter and extracted by the extraction unit; and
a display controller to sequentially display the tomographic images one by one captured in he multiple examinations in the same display area on a display, the tomographic images being coordinated by the coordination unit.
